(19) United States
(12) Patent Application Publication
(10) Pub. No.: US 2013/0097626 A1
(43) Pub. Date: Apr. 18, 2013

(54) Multi-User IPTV Client Device

(71) Applicants: Priya Rajagopal, Ann Arbor, MI (US); Fred F. Hasle, Manotick (CA)

(72) Inventors: Priya Rajagopal, Ann Arbor, MI (US); Fred F. Hasle, Manotick (CA)

(73) Assignee: General Instrument Corporation, Horsham, PA (US)

(21) Appl. No.: 13/271,823

(22) Filed: Oct. 12, 2011

(51) Int. Cl. H04N 7/16

(52) U.S. Cl. 725/25

(57) ABSTRACT

In embodiments of a multi-user IPTV client device, an IPTV session is initialized with a content distributor that delivers video content to the client device. The client device enforces content viewing rights based on user privilege levels, and receives the video content for display of non-restricted video content based on a default user privilege level associated with the client device. An individual user having an individual user privilege level that is associated with the client device is then authorized, and the individual user privilege level replaces the default user privilege level, allowing playback of restricted video content. The client device continues to receive the video content uninterrupted when the default user privilege level is switched to the individual user privilege level at the client device.

### BACKGROUND

Internet-Protocol based TV (IPTV) is the delivery of digital television content and interactive or personalized video services over a broadband channel using IP protocol. The IP Multimedia Service (IMS) is an industry standard framework that provides a common platform for such IPTV services, such as delivery of both IPTV and other communications services. A client set-top box (STB) may be configured for multiple users, where the set-top box can be associated with multiple individual user accounts and IPTV services are targeted for the current user that is logged-in at the set-top box. Depending on the current logged-in or registered user, the IPTV network can customize or personalize the services that are delivered. Television content can also be delivered on a per-user basis, rather than merely on a per-device basis. However, when multiple users log-in, log-off, and switch users at a client set-top box, there can be an interruption of the IPTV services for network registration and authentication of the different users.

### BRIEF DESCRIPTION OF THE DRAWINGS

Embodiments of a multi-user IPTV client device are described with reference to the following Figures. The same numbers may be used throughout to reference like features and components that are shown in the Figures:

FIG. 1 illustrates an example system in which embodiments of a multi-user IPTV client device can be implemented.

FIG. 2 illustrates an example of initial startup for a multi-user IPTV client device in accordance with one or more embodiments.

FIG. 3 illustrates an example of a switch from a default user privilege level to an individual user privilege level at a multi-user IPTV client device in accordance with one or more embodiments.

FIG. 4 illustrates an example of a switch from a first individual user privilege level to a second individual user privilege level at a multi-user IPTV client device in accordance with one or more embodiments.

FIG. 5 illustrates an example of a switch from an individual user privilege level to a default user privilege level at a multi-user IPTV client device in accordance with one or more embodiments.

FIG. 6-8 illustrates example method(s) of a multi-user IPTV client device in accordance with one or more embodiments.

FIG. 9 illustrates example method(s) of a content distributor that delivers video content to a multi-user IPTV client device in accordance with one or more embodiments.

FIG. 10 illustrates various components of an example electronic device that can implement embodiments of a multi-user IPTV client device.

### DETAILED DESCRIPTION

In embodiments, a multi-user IPTV client device can be any type of a television set-top box or a computer device that is implemented as a shared IPTV client device. An IPTV client device can support multiple users, each associated with a different user account, and video content and IPTV services at the client device are delivered in the context of a current, active user that is logged-in at the device. When users are switched at the client device, such as when a user is logged-off and/or another user is logged-in, the video content continues to be delivered to the client device uninterrupted in the context of the default user regardless of the current, active user that is logged-in at the device. Embodiments of a multi-user IPTV client device avoid service disruption, such as the delivery of the video content from a content distributor, when users are logged-in and logged-off from a client device, and/or when users are switched.

While features and concepts of a multi-user IPTV client device can be implemented in any number of different devices, systems, networks, and/or configurations, embodiments of a multi-user IPTV client device are described in the context of the following example devices, systems, and methods.

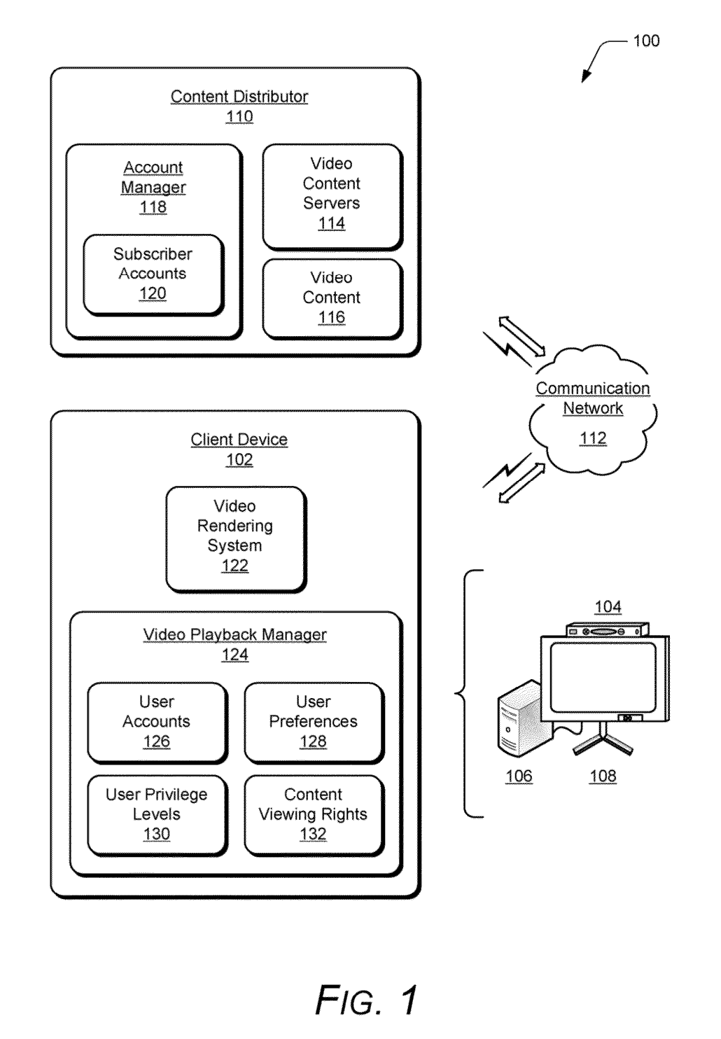

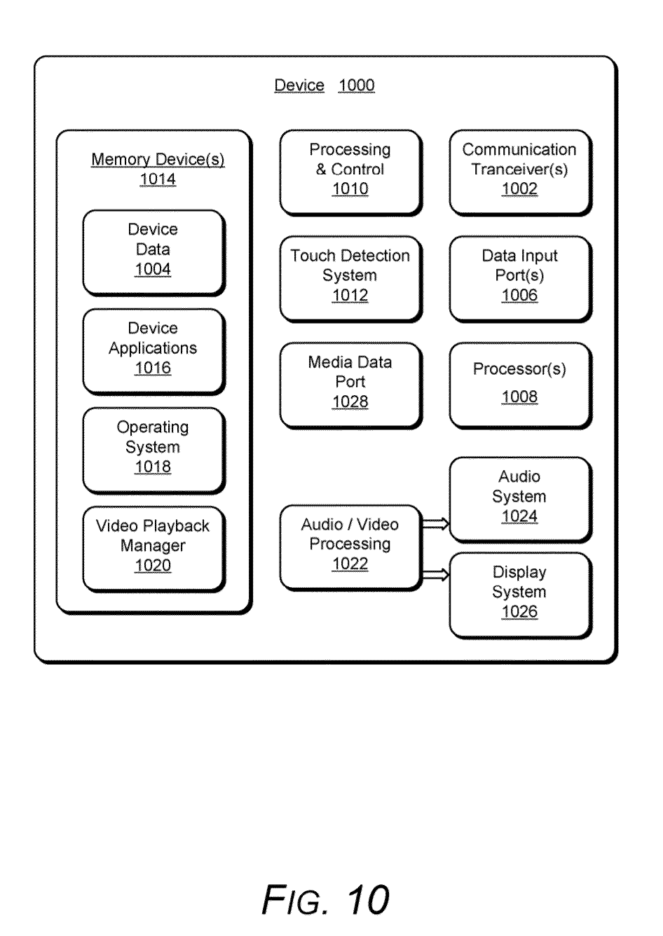

FIG. 1 illustrates an example system 100 in which embodiments of a multi-user IPTV client device can be implemented. The example system 100 includes a client device 102, which may be any one or combination of a fixed or mobile device, in any form of a consumer, computer, portable, user, media playback, gaming, and/or electronic device that can be configured as an IPTV client device to receive and playback video content. For example, the client device 102 can be implemented as a television set-top box 104 or a computer device 106 that are shared IPTV devices connected to a display device 108 to display video content. Alternatively, a client device may be a portable device that includes an integrated display to display the video content. Any of the client devices can be implemented with various components, such as one or more processors and memory devices, as well as with any combination of differing components as further described with reference to the example electronic device shown in FIG. 10.

The example system 100 also includes a content distributor 110 and/or other video content sources that deliver video content and data to any number of the various client devices via a communication network 112. In embodiments, the content distributor is an IPTV network service that distributes television content to the client device 102 via an IP-based network. Any of the services and devices can communicate via the communication network, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

The content distributor 110 includes video content servers 114 to distribute video content 116 to the various client devices. The video content can include any type of audio, video, and/or image data in the form of television programming, movies, on-demand video, interactive games, advertisements, and the like. The video content may also be distributed in various display formats, such as a high-definition display format and lower quality display formats. The content distributor can be implemented with various components, such as one or more processors and memory devices, as well as with any combination of differing components as further described with reference to the example electronic device shown in FIG. 10. For example, the content distributor includes storage media, such as any type of memory and/or suitable electronic data storage, to store or otherwise maintain the video content and other data.

In the example system 100, the content distributor 110 includes an account manager 118 that is implemented to manage subscriber accounts 120. A subscriber account corresponds to a user and/or to any number of different client devices of a user, and a subscriber account may include such information as user preferences and configuration of services. The account manager 118 can be implemented as computer-executable instructions, such as a software application, and executed by one or more processors to implement the various embodiments described herein.

In the example system 100, the client device 102 includes a video rendering system 122 that is implemented to process and generate video content for display, such as on the display device 108 that is connected to the client device, or on a display device that is integrated with the client device. The client device 102 also includes a video playback manager 124 that can be implemented as computer-executable instructions, such as a software application, and executed by one or more processors to implement the various embodiments described herein. The video playback manager is implemented to manage user accounts 126 that correspond to users of the client device. The client device can be associated with the set of valid user accounts, one of which is a default subscriber account 120. When the client device initiates to setup a video session with the content distributor 110, the client device can be registered and authenticated at the content distributor with the default subscriber account.

The video playback manager 124 also manages user preferences 128, user privilege levels 130, and content viewing rights 132 that are associated with a respective user account. For example, the video playback manager is implemented to enforce the content viewing rights based on a user privilege level that corresponds to a user account for a user that is logged-in at the client device. Each user of the client device 102 is associated with a specific user privilege level that defines an access level (e.g. adult, teen, general audience, family, individual, child, etc.) to video content that the user is authorized for viewing.

A user at a specific privilege level can only access video content that is equal to or below the user privilege level that is associated with the user account of the user. As described herein, video content that is equal to or below a particular user privilege level is unrestricted video content, whereas video content that is above a particular user privilege level is restricted video content. As such, the video content may be unrestricted or restricted based on the user privilege levels 130 that are associated with the respective user accounts 126. In implementations, the user privilege levels include a default user privilege level that is configured at a lowest privilege level, and by default, all of the users of the client device 102 have access to unrestricted video content. Other users have higher privilege levels that allow a particular user to watch video content that would otherwise be restricted and not available to all of the users at the client device. The user privilege levels for video content access is enforced locally by the video playback manager 124 so that a user who is associated with a respective user account 126 can only view the video content according to the corresponding user privilege level 130.

The client device 102 can support multiple users, each associated with a different user account 126, and video content and IPTV services at the client device are delivered in the context of a current user (also referred to as the active user) that is logged-in at the device. For example, a user specific SIP session (i.e., session initiation protocol) can be established for delivering content from the content distributor 110 to the client device. However, with SIP sessions, switching users at a client device typically involves terminating the video session of one user before a new video session for a next user can be established, thereby disrupting the video services. However, in embodiments of a multi-user IPTV client device, video content is delivered uninterrupted in the context of the default user regardless of the current, active user that is logged-in at the device.

The user preferences 128 correspond to the respective user accounts 126, and the user account that is associated with the current, active user that is logged-in at the client device 102 is used to personalize the viewing experience for the user. A personalized viewing experience can include a personalized context guide, customized graphics and background, and can be applied to other non-IPTV based communication services, such as for VOIP, chat, instant messaging, callerId alerts, and the like. Since the default user is always logged-in to the IPTV network at the client device, delivery of the video content is not disrupted, even when a new user is logged-in or when there is a user switch as long as the privilege levels of the new active user permit displaying the video content for viewing.

A user can log-in at the client device and the account manager 118 at the content distributor 110 registers and authenticates the user to the service. Additionally, a user can log-off from the client device and/or users can be switched by logging-off a first user and logging-in a second user. Embodiments of a multi-user IPTV client device avoid service disruption, such as the delivery of video content from the content distributor, when users are logged-in and logged-off from a client device, and/or when users are switched.

Switching of users at the client device can be accomplished based on a user request to log-off, or the client device may log-off the current user when an extended period of inactivity is detected. For example, the client device may detect a lack of input to the client device for a duration of time, such as not receiving a volume control input, a channel change input, or a video content control input for the duration of time. An extended period of inactivity and/or a lack of input to the client device may indicate that the logged-in user has left the room, leaving restricted video content available for viewing by a user that does not have a corresponding user privilege level to watch the restricted video content.

In other example scenarios, a user may be watching television and another user wants to log-in at the client device and schedule a recording of program without disrupting the video content that is being watched by first user. In another example, a user may be watching a television program and leave the room, forgetting to log-off and/or turn-off the client device. Another user with at least an equal user privilege level may continue watching the television program and, after a duration of time, the second user is prompted for a PIN (personal identification number) refresh. Assuming the second user provides the relevant PIN, the user is able to continue watching the television program without disruption or interruption to the video content stream that is being delivered to the client device. In another example, two users may be watching a television program and one of them leaves. The remaining user then wants to instant message with friends and logs-in at the client device with his or her own user account while continuing the watch the television program. Accordingly, the video content stream that is being delivered to the client device is not interrupted to log-in the user and/or to enable instant messaging.

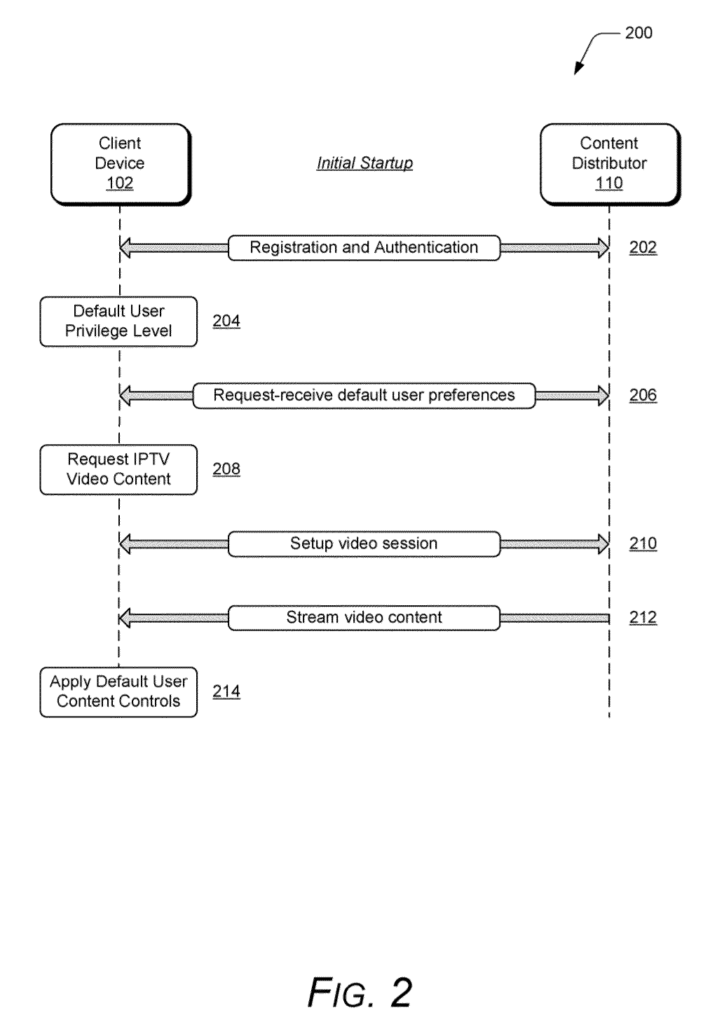

FIG. 2 illustrates an example 200 of initial startup for a multi-user IPTV client device, such as implemented at the client device 102 in communication with the content distributor 110 as described with reference to FIG. 1. In the example 200, the video playback manager 124 at the client device 102 can initialize an IPTV session with the content distributor by a registration and authentication procedure at 202. The log-in process registers and authenticates the default user at the default user privilege level 204 with the content distributor in the IPTV network. Subsequent to the log-in session, an IPTV service request is initiated at 206 to receive personalized and/or customized service listings based on the default user privilege level.

The video playback manager 124 at the client device 102 can request IPTV video content at 208, and a video session is setup with the content distributor at 210. The content distributor can then deliver the video content at 212 for display of non-restricted video content based on the default user privilege level at the client device. The video playback manager 124 can then apply and enforce the default user content controls at 214 without interruption to the video content stream that is being received from the content distributor.

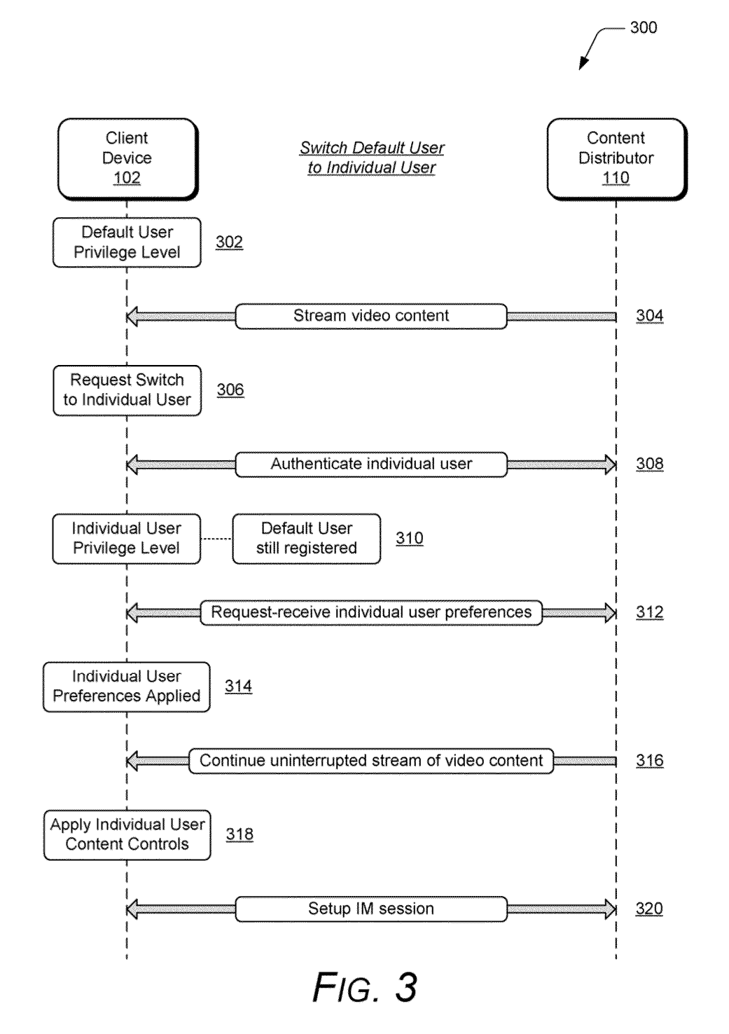

FIG. 3 illustrates an example 300 of a switch from a default user privilege level to an individual user privilege level at a multi-user IPTV client device, such as implemented at the client device 102 in communication with the content distributor 110 described with reference to FIG. 1. In the example 300, the default user with the default user privilege level is logged-in at the client device at 302, and the video content is streamed from the content distributor to the client device at 304. The video playback manager 124 can receive a request at 306 to switch from the default user privilege level to an individual user (e.g. log-in a different user at the client device). For example, the video playback manager can receive an authorization code to authorize the individual user, and communicate a request to the content distributor at 308 to authenticate the individual user.

The user is logged-in to the client device 102 with a corresponding individual user privilege level that allows playback of restricted video content, and the default user privilege level is still registered at 310. An IPTV service request is initiated at 312 to receive personalized and/or customized service listings based on the individual user privilege level, and the individual user preferences are applied at 314. The video rendering system 122 at the client device continues to receive the video content uninterrupted at 316 when the default user privilege level is switched to the individual user privilege level, and the individual user content controls are applied at 318. In an embodiment, an instant messaging session may be setup at 320 with a communication link established between the client device and another messaging-enabled device. The video content continues to be received uninterrupted at the client device when the instant messaging session is setup.

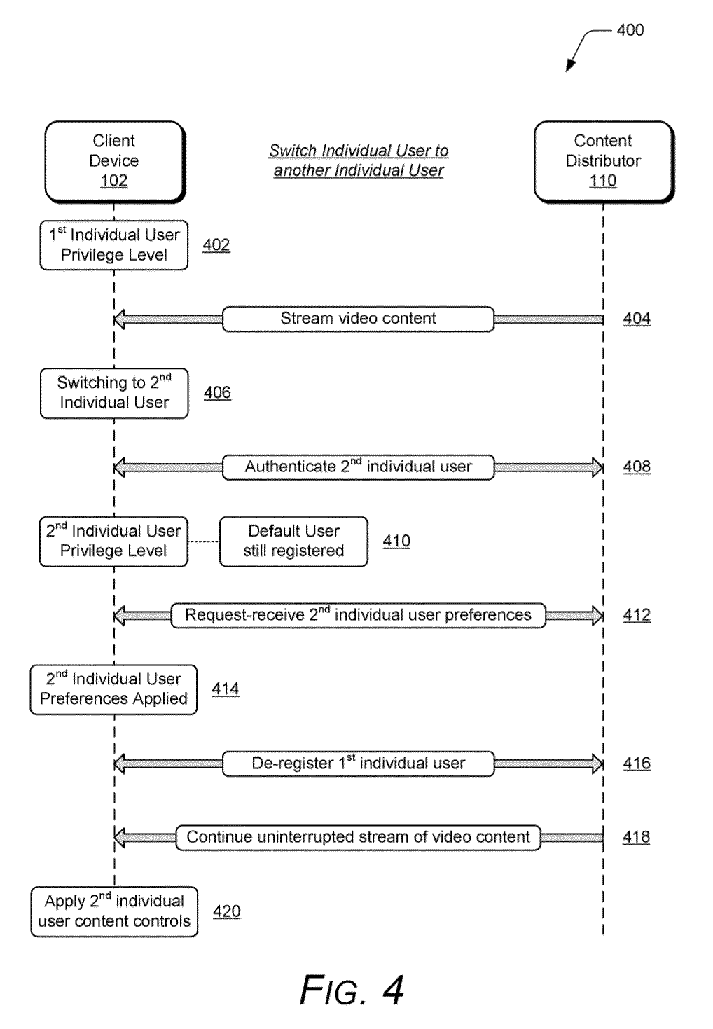

FIG. 4 illustrates an example 400 of a switch from a first individual user privilege level to a second individual user privilege level at a multi-user IPTV client device, such as implemented at the client device 102 in communication with the content distributor 110 described with reference to FIG. 1. In the example 400, a first user with a first individual user privilege level is logged-in to the client device at 402, and the video content is streamed from the content distributor to the client device at 404. The video playback manager 124 can receive a request at 406 to switch from the first individual user privilege level to second individual user privilege level (e.g., log-in a different user at the client device). The video playback manager can then communicate a request to the content distributor at 408 to authenticate the second individual user.

The second user is logged-in to the client device 102 with a corresponding individual user privilege level, and the default user privilege level is still registered at 410. An IPTV service request is initiated at 412 to receive personalized and/or customized service listings based on the second individual user privilege level, and the individual user preferences are applied at 414. The first individual user can then be de-registered, and the video rendering system 122 at the client device continues to receive the video content uninterrupted at 416 when the first individual user privilege level is switched to the second individual user privilege level. In implementations, the video playback manager 124 may authorize a different user privilege level that limits the content viewing rights of the restricted video content at the client device. Alternatively, the different user privilege level may have at least equal content viewing rights of the restricted video content, and the video rendering system continues to receive the video content without interruption to playback the restricted video content when the different user privilege level is authorized.

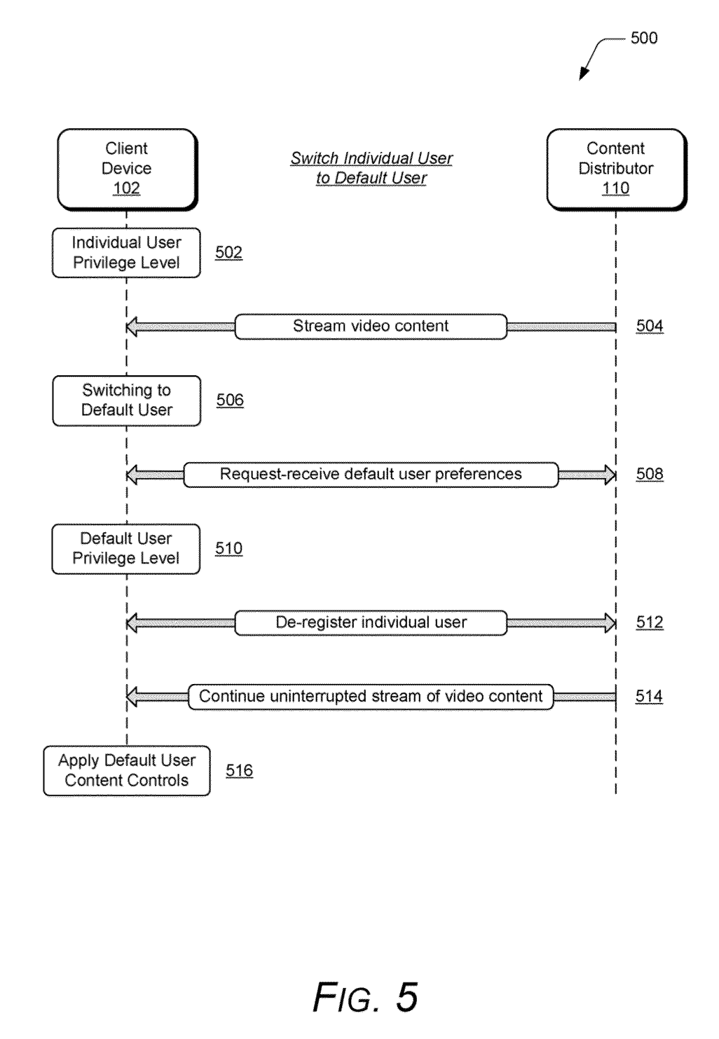

FIG. 5 illustrates an example 500 of a switch from an individual user privilege level to a default user privilege level at a multi-user IPTV client device, such as implemented at the client device 102 in communication with the content distributor 110 described with reference to FIG. 1. In the example 500, a user with an individual user privilege level is logged-in to the client device at 502, and the video content is streamed from the content distributor to the client device at 504. The video playback manager 124 can receive a request at 506 to switch from the individual user privilege level back to the default user privilege level. For example, the video playback manager can receive a request to log-off the individual user privilege level, or detect a lack of input to the client device for a duration of time, and revert back to the default user privilege level.

An IPTV service request is initiated at 508 to receive the default user preferences based on the default user privilege level at 510, and the individual user can then be de-registered at 512. The video rendering system 122 at the client device 102 continues to receive the video content uninterrupted at 514 when the individual user privilege level reverts back to the default user privilege level and the default user content controls are applied at 516.

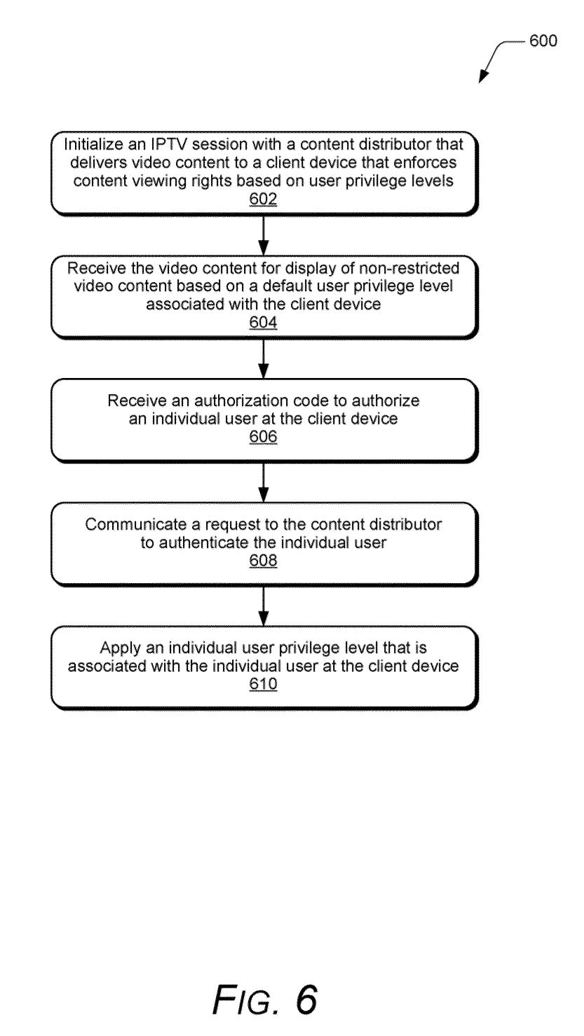

Example methods 600, 700, 800, and 900 are described with reference to respective FIGS. 6-9 in accordance with one or more embodiments of a multi-user IPTV client device. Generally, any of the services, functions, methods, procedures, components, and modules described herein can be implemented using software, firmware, hardware (e.g. fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 6 illustrates example method(s) 600 of a multi-user IPTV client device. The order in which the method blocks are described are not intended to be construed as a limitation, and any number or combination of the described method blocks can be combined in any order to implement a method, or an alternate method.

At block 602, an IPTV session is initialized with a content distributor that delivers video content to a client device that enforces content viewing rights based on user privilege levels. For example, the video playback manager 124 at the client device 102 (FIG. 1) initializes an IPTV session with the content distributor 110 to register and authenticate a user at the client device. The content distributor then delivers the video content 116 to the client device that enforces the content viewing rights 132 based on the user privilege levels 130 that are associated with the respective user accounts 126.

At block 604, the video content is received for display of non-restricted video content based on a default user privilege level associated with the client device. For example, the video rendering system 122 at the client device 102 receives the video content 116 from the content distributor 110 for display of non-restricted video content based on the default user privilege level that is associated with the client device. The default user privilege level allows all of the users that are associated with the client device access to unrestricted video content. Other users that have higher user privilege levels can watch video content that would otherwise be restricted and not available to all of the users at the client device. The video playback manager 124 enforces the user privilege levels 130 locally at the client device so that a user who is associated with a respective user account 126 can only view video content according to the corresponding user privilege level.

At block 606, an authorization code is received to authorize an individual user at the client device and, at block 608, a request is communicated to the content distributor to authenticate the individual user. For example, the video playback manager 124 at the client device 102 receives an authorization code, such as a user-assigned PIN entered by a user, and communicates a request to the content distributor 110 to authenticate the individual user.

At block 610, the individual user is authorized and an individual user privilege level that is associated with the user is applied. For example, the video playback manager 124 at the client device 102 replaces the default privilege level with the individual user privilege level, thus allowing playback of restricted video content at the client device. At block 612, the video content continues to be received uninterrupted when the default user privilege level is switched to the individual user privilege level at the client device. For example, the client device 102 continues to receive the video content 116 from the content distributor 110 without interruption when the default user privilege level is switched to the individual user privilege level.

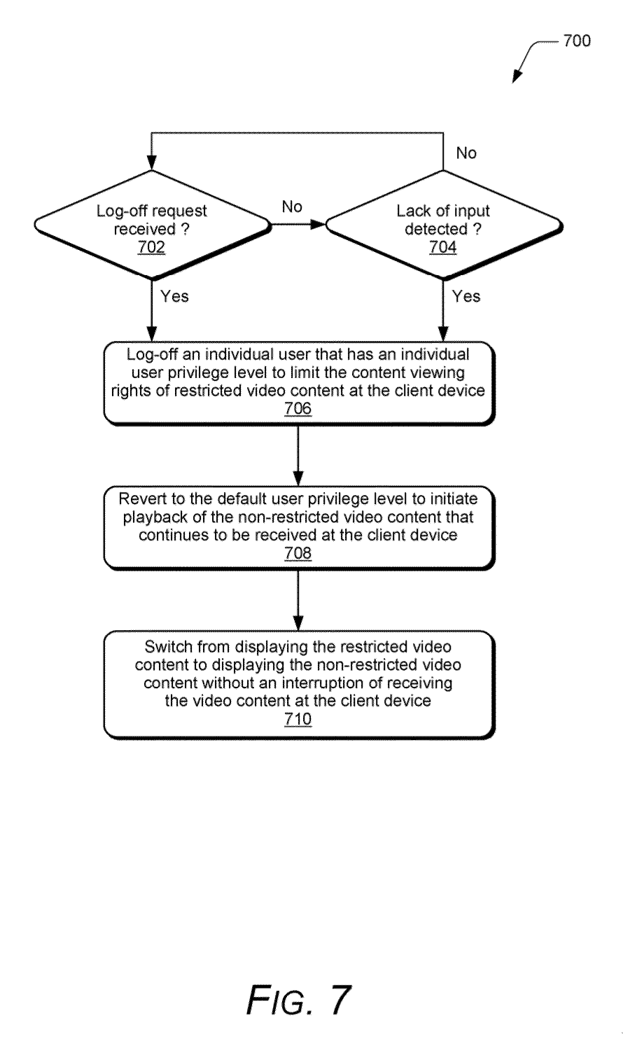

FIG. 7 illustrates example method(s) 700 of a multi-user IPTV client device. The order in which the method blocks are described are not intended to be construed as a limitation, and any number or combination of the described method blocks can be combined in any order to implement a method, or an alternate method.

At block 702, a determination is made as to whether a log-off request is received. For example, the current registered, active user at the client device 102 (FIG. 1) may initiate an input to log-off from the IPTV service, and the client device receives the request to log-off the individual user that has an associated individual user privilege level. If a log-off request is not received (i.e., no from block 702), then at block 704, a determination is made as to whether a lack of input is detected at the client device. For example, the video playback manager 124 at the client device 102 detects an extended period of inactivity, such as a lack of input for a duration of time. A lack of input can include not receiving a volume control input, a channel change input, or a video content control input for the duration of time.

If a log-off request is received (i.e. yes from block 702), or if a lack of input is detected at the client device (i.e. yes from block 704), then at block 706, the individual user having an individual user privilege level is logged-off to limit the content viewing rights of restricted video content at the client device. For example, the video playback manager 124 at the client device 102 logs-off the current, active user that has an individual user privilege level to limit the content viewing rights of restricted video content at the client device.

At block 708, privilege is reverted back to the default user privilege level to initiate playback of the non-restricted video content that continues to be received at the client device. For example, the video playback manager 124 at the client device 102 reverts from the individual user privilege level back to the default user privilege level to initiate playback of the non-restricted video content that continues to be received uninterrupted at the client device.

At block 710, the video content is switched from displaying the restricted video content to displaying the non-restricted video content without an interruption of receiving the video content at the client device. For example, the video rendering system 122 at the client device 102 switches playback from the restricted video content to display the non-restricted video content without an interruption of receiving the video content from the content distributor 110 at the client device.

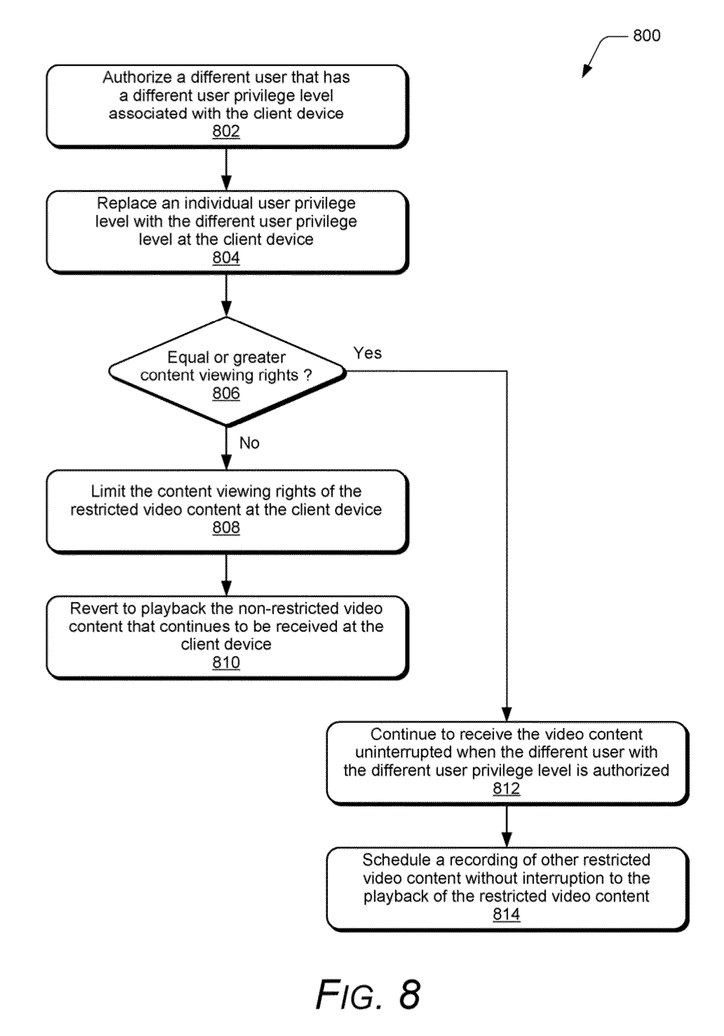

FIG. 8 illustrates example method(s) 800 of a multi-user IPTV client device. The order in which the method blocks are described are not intended to be construed as a limitation, and any number or combination of the described method blocks can be combined in any order to implement a method, or an alternate method.

At block 802, a different user having a different user privilege level associated with the client device is authorized and, at block 804, an individual user privilege level is replaced with the different user privilege level at the client device. For example, the video playback manager 124 at the client device 102 authorizes a different user that has a different user privilege level than a current, active user who is logged-in to the client device. The video playback manager then replaces the individual user privilege level that is associated with the current, active user with the different user privilege level that is associated with the different, authorized user.

At block 806, a determination is made as to whether the different user privilege level has equal or greater content viewing rights as the individual user privilege level that is being replaced. For example, the video playback manager 124 at the client device 102 determines whether the different user privilege level that is associated with the different, authorized user has equal or greater content viewing rights as the individual user privilege level that is being replaced.

If the different user privilege level does not have at least equal or greater content viewing rights as the individual user privilege level that is being replaced (i.e. no from block 806), then at block 808, the content viewing rights of the restricted video content is limited at the client device. For example, the video playback manager 124 at the client device 102 limits the content viewing rights of the restricted video content if the different user privilege level does not have at least equal or greater content viewing rights as the individual user privilege level that is being replaced. At block 810, playback reverts to the non-restricted video content that continues to be received at the client device. For example, the video rendering system 122 at the client device reverts to playback the non-restricted video content that continues to be received uninterrupted from the content distributor 110 at the client device.

If the different user privilege level does have at least equal or greater content viewing rights as the individual user privilege level that is being replaced (i.e., yes from block 806), then at block 812, the video content continues to be received uninterrupted when the different user is authorized at the client device. For example, the video rendering system 122 at the client device continues to receive and playback the restricted video content uninterrupted when the different user with the different user privilege level is authorized at the client device.

At block 814, a recording of other restricted video content is scheduled without interruption to the playback of the restricted video content. For example, the video playback manager 124 at the client device 102 schedules a recording of other restricted video content based on a user-input request from the different, authorized user when the different user is authorized and the video content continues to be received uninterrupted from the content distributor 110.

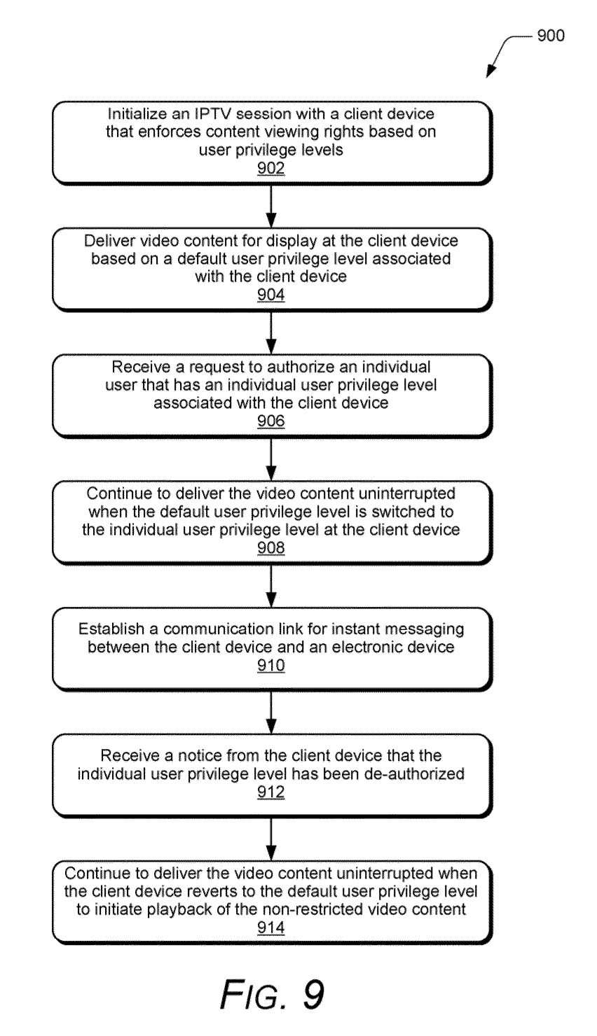

FIG. 9 illustrates example method(s) 900 of a content distributor that delivers video content to a multi-user IPTV client device. The order in which the method blocks are described are not intended to be construed as a limitation, and any number or combination of the described method blocks can be combined in any order to implement a method, or an alternate method.

At block 902, an IPTV session is initialized with a client device that enforces content viewing rights based on user privilege levels. For example, the content distributor 110 (FIG. 1) initializes an IPTV session with the client device 102 to register and authenticate a user. The client device enforces the content viewing rights 132 based on the user privilege levels 130 that are associated with the respective user accounts 126.

At block 904, video content is delivered for display at the client device based on a default user privilege level associated with the client device. For example, the content distributor 110 delivers the video content 116 to the client device 102 where the restricted and/or unrestricted video content is displayed for viewing based on the user privilege levels 130 at the client device.

At block 906, a request is received to authorize an individual user having an individual user privilege level that is associated with the client device. For example, the content distributor 110 receives a request from the client device 102 to authorize an individual user that has an individual user privilege level replacing the default user privilege level and allowing playback of restricted video content at the client device.

At block 908, the video content continues to be delivered uninterrupted when the default user privilege level is switched to the individual user privilege level at the client device. For example, the content distributor 110 continues to deliver the video content 116 to the client device 102 uninterrupted when the default user privilege level is switched to the individual user privilege level at the client device.

At block 910, a communication link is established for instant messaging between the client device and an electronic device. For example, the content distributor 110 establishes a communication link for instant messaging between the client device 102 and another messaging-enabled device without interrupting playback of the unrestricted and/or restricted video content at the client device.

At block 912, a notice is received from the client device that the individual user privilege level has been de-authorized and, at block 914, the video content continues to be delivered uninterrupted when the client device reverts to the default user privilege level to initiate playback of the non-restricted video content. For example, the content distributor 110 receives a notice from the client device 102 that the current, active user has been de-authorized at the client device. The content distributor continues to deliver the video content 116 uninterrupted when the client device reverts to the default user privilege level to initiate playback of the non-restricted video content.

FIG. 10 illustrates various components of an example electronic device 1000 that can be implemented as any device described with reference to any of the previous FIGS. 1-9. The electronic device may be implemented as an IPTV client device to receive and playback video content, and as any one or combination of a fixed or mobile device, in any form of a consumer, computer, portable, user, media playback, gaming, and/or electronic device.

The electronic device 1000 includes communication transceivers 1002 that enable wired and/or wireless communication of device data 1004, such as received data, data that is being received, data scheduled for broadcast, data packets of the data, etc. Example transceivers include wireless personal area network (WPAN) radios compliant with various IEEE 802.15 (sometimes referred to as Bluetooth™) standards, wireless local area network (WLAN) radios compliant with any of the various IEEE 802.11 (sometimes referred to as WiFi™) standards, wireless wide area network (WWAN) radios for cellular telephony, wireless metropolitan area network (WMAN) radios compliant with various IEEE 802.15 (sometimes referred to as WiMAX™) standards, and wired local area network (LAN) Ethernet transceivers.

The electronic device 1000 may also include one or more data input ports 1006 via which any type of data media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory. DVDs, CDs, and the like. These data input ports may be used to couple the electronic device to components, peripherals, or accessories such as microphones or cameras.

The electronic device 1000 includes one or more processors 1008 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 1010. The electronic device also includes a touch detection system 1012 that is implemented to detect and/or sense touch contacts, such as when initiated by a user as a selectable touch input on a touch gesture interface integrated with the device. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 1000 also includes one or more memory devices 1014 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 1000 may also include a mass storage media device.

A memory device 1014 provides data storage mechanisms to store the device data 1004, other types of information and/or data, and various device applications 1016 (e.g., software applications). For example, an operating system 1018 can be maintained as software instructions within a memory device and executed on the processors 1008. The device applications may also include a device manager, such as any form of a control application, software application, signal-processing and control module, code that is native to a particular device, a hardware abstraction layer for a particular device, and so on. In embodiments, the electronic device also includes a video playback manager 1020 to implement a multi-user IPTV client device.

The electronic device 1000 also includes an audio and/or video processing system 1022 that generates audio data for an audio system 1024 and/or generates display data for a display system 1026. The audio system and/or the display system may include any devices that process, display, and/or otherwise render audio, video, display, and/or image data. Display data and audio signals can be communicated to an audio component and/or to a display component via an RF (radio frequency) link. S-video link, HDMI (high-definition multimedia interface), composite video link, component video link, DVI (digital video interface), analog audio connection, or other similar communication link, such as media data port 1028. In implementations, the audio system and/or the display system are external components to the electronic device. Alternatively, the audio system and/or the display system are integrated components of the example electronic device, such as an integrated touch gesture interface.

As described above, an IPTV client device can support multiple users, each associated with a different user account, and video content and IPTV services at the client device are delivered in the context of a current, active user that is logged-in at the device. When users are switched at the client device, such as when a user is logged-off and/or another user is logged-in, video content continues to be delivered to the client device uninterrupted in the context of the default user regardless of the current, active user that is logged-in on the device. Although embodiments of a multi-user IPTV client device have been described in language specific to features and/or methods, the subject of the appended claims is not necessarily limited to the specific features or methods described. Rather, the specific features and methods are disclosed as example implementations of a multi-user IPTV client device.

1. A method, comprising:
initializing an IPTV session with a content distributor that delivers video content to a client device that enforces content viewing rights based on user privilege levels;
receiving the video content for display of non-restricted video content based on a default user privilege level associated with the client device;
authorizing an individual user having an individual user privilege level that is associated with the client device, the individual user privilege level replacing the default user privilege level and allowing playback of restricted video content at the client device; and
continuing to receive the video content uninterrupted when the default user privilege level is switched to the individual user privilege level at the client device.

2. A method as recited in claim 1, further comprising:
receiving an authorization code to authorize the individual user at the client device; and
communicating a request to the content distributor to authenticate the individual user.

3. A method as recited in claim 1, further comprising:
receiving a request to log-off the individual user and limit the content viewing rights of the restricted video content at the client device; and
reverting to the default user privilege level to initiate playback of the non-restricted video content that continues to be received at the client device.

4. A method as recited in claim 3, further comprising:
switching from displaying the restricted video content to said displaying the non-restricted video content without an interruption of receiving the video content at the client device.

5. A method as recited in claim 1, further comprising:
detecting a lack of input to the client device for a duration of time;
logging-off the individual user to limit the content viewing rights of the restricted video content at the client device; and
reverting to the default user privilege level to initiate playback of the non-restricted video content that continues to be received at the client device.

6. A method as recited in claim 5, wherein said detecting a lack of input comprises not receiving at least one of a volume control input, a channel change input, or a video content control input for the duration of time.

7. A method as recited in claim 1, further comprising:
authorizing a different user having a different user privilege level that is associated with the client device, the different user privilege level replacing the individual user privilege level and limiting the content viewing rights of the restricted video content at the client device; and
reverting to playback the non-restricted video content that continues to be received at the client device.

8. A method as recited in claim 1, further comprising:
authorizing a different user having a different user privilege level that is associated with the client device, the different user privilege level replacing the individual user privilege level with at least equal content viewing rights of the restricted video content at the client device; and
continuing to receive the video content uninterrupted when said authorizing the different user at the client device.

9. A method as recited in claim 1, further comprising:
authorizing a different user having a different user privilege level that is associated with the client device, the different user privilege level replacing the individual user privilege level with at least equal content viewing rights of the restricted video content at the client device; and
scheduling a recording of other restricted video content without interruption to the playback of the restricted video content at the client device when said authorizing the different user.

10. A method, comprising:
initializing an IPTV session with a client device that enforces content viewing rights based on user privilege levels;
delivering video content for display at the client device based on a default user privilege level associated with the client device;
receiving a request to authorize an individual user having an individual user privilege level that is associated with the client device, the individual user privilege level replacing the default user privilege level and allowing playback of restricted video content at the client device; and
continuing to deliver the video content uninterrupted when the default user privilege level is switched to the individual user privilege level at the client device.

11. A method as recited in claim 10, further comprising:
establishing a communication link for instant messaging between the client device and an electronic device, said instant messaging without interrupting playback of the restricted video content at the client device.

12. A method as recited in claim 10, further comprising:
receiving a notice from the client device that the individual user with the individual user privilege level has been de-authorized; and
continuing to deliver the video content uninterrupted when the client device reverts to the default user privilege level to initiate playback of the non-restricted video content.

13. A client device, comprising:
a memory and a processor to execute a video playback manager that is configured to:
enforce content viewing rights based on user privilege levels at the client device;
initialize an IPTV session with a content distributor that delivers video content for display of non-restricted video content based on a default user privilege level;
authorize an individual user having an individual user privilege level that replaces the default user privilege level and allows playback of restricted video content; and
a video rendering system configured to receive the video content uninterrupted when the default user privilege level is switched to the individual user privilege level.

14. The client device as recited in claim 13, wherein the video playback manager is further configured to:
receive an authorization code to authorize the individual user; and
communicate a request to the content distributor to authenticate the individual user.

15. The client device as recited in claim 13, wherein the video playback manager is further configured to:
receive a request to log-off the individual user that limits the content viewing rights of the restricted video content; and
revert to the default user privilege level to initiate playback of the non-restricted video content that continues to be received at the client device.

16. The client device as recited in claim 15, wherein the video rendering system is further configured to switch from the restricted video content being displayed to the non-restricted video content being displayed without an interruption of the video content being received.

17. The client device as recited in claim 13, wherein the video playback manager is further configured to:
detect a lack of input to the client device for a duration of time;
log-off the individual user that limits the content viewing rights of the restricted video content at the client device; and
revert to the default user privilege level to initiate playback of the non-restricted video content that continues to be received at the client device.

18. The client device as recited in claim 13, wherein the video playback manager is further configured to:
authorize a different user having a different user privilege level that replaces the individual user privilege level and limits the content viewing rights of the restricted video content at the client device; and
revert to playback the non-restricted video content that continues to be received.

19. The client device as recited in claim 13, wherein the video playback manager is further configured to:
authorize a different user having a different user privilege level that replaces the individual user privilege level with at least equal content viewing rights of the restricted video content; and wherein
the video rendering system continues to receive the video content without interruption to playback the restricted video content when the different user is authorized.

20. The client device as recited in claim 13, wherein the video playback manager is further configured to:
authorize a different user having a different user privilege level that replaces the individual user privilege level with at least equal content viewing rights of the restricted video content; and
schedule a recording of other restricted video content without interruption to the playback of the restricted video content when the different user is authorized.
